(19) United States
(12) Patent Application Publication
(10) Pub. No.: US 2022/0283907 A1
(43) Pub. Date: Sep. 8, 2022

(54) Organizational Awareness for Automating Data Protection Policies Using Historical Weighting

(71) Applicant: EMC IP Holding Company LLC, Hopkinton, MA (US)

(72) Inventors: Arun Murti, Mission Viejo, CA (US); Mark Malamut, Aliso Viejo, CA (US); Adam Brenner, Mission Viejo, CA (US)

(21) Appl. No.: 17/471,153

(22) Filed: Sep. 9, 2021

Related U.S. Application Data
(63) Continuation-in-part of application No. 17/193,342, filed on Mar. 5, 2021.

(51) Int. Cl. G06F 11/14; G06Q 10/10

(52) U.S. Cl. CPC G06F 11/1461; G06Q 10/10; G06F 2201/80

(57) ABSTRACT

Embodiments for automating backup policy application to users in a data protection system of an organization, by defining a plurality of backup policies to apply to data processed by users in the organization, wherein each backup policy dictates a different performance characteristic based on storage cost and target storage type and location. Next, identifying a hierarchical position of a user within the organization and determining communication and grouping behavior of the user within the organization. A score is calculated for the user based on their hierarchical position and communication and grouping behavior, and an appropriate backup policy is assigned to the user based on their total score. If a user moves upward, a stronger protection policy is immediately applied, whereas is user moves down, a weaker protection policy is applied after a period of time to extend strong data protection if desired

### CROSS-REFERENCE TO RELATED APPLICATIONS

The present application is a Continuation-In-Part application and claims priority to U.S. patent application Ser. No. 17/193,342 filed on Mar. 5, 2021, entitled “Organizational Awareness For Automating Data Protection Policies,” and assigned to the assignee of the present application.

### TECHNICAL FIELD

Embodiments relate generally to data protection, and more specifically to incorporating organizational awareness and historical data for automating data protection policies.

### BACKGROUND

Backup software is used by large organizations to store their data for recovery after system failures, routine maintenance, archiving, and so on. Backup sets are typically taken on a regular basis, such as hourly, daily, weekly, and so on, and can comprise vast amounts of information. Backup programs are often provided by vendors that provide backup infrastructure (software and/or hardware) to customers under service level agreements (SLA) that set out certain service level objectives (SLO) that dictate minimum standards for important operational criteria such as uptime and response time, etc. Within a large organization, dedicated IT personnel or departments are typically used to administer the backup operations and work with vendors to resolve issues and keep their infrastructure current.

Data within an organization is typically not considered to be monolithic as far as data protection policies are concerned. As enterprise systems grow and become more complex, the data for different assets within the organization, such as personnel, machines, data sources, and so on may be assigned different data protection policies so that storage costs and SLOs can be optimally tailored to the appropriate types of data.

In present systems, data assets are manually assigned to specific policies by system administrators in what is largely a manual process. Some advanced systems, such as VMware platforms, may allow assets to be automatically assigned to policies based on virtual center (vCenter) tags, but the mappings between policies and tags must still be manually configured by administrators. Other backup software products may custom protect certain types of data, such as e-mail systems (e.g., Microsoft Exchange) based on information from directory services like LDAP (Lightweight Directory Access Protocol) or Microsoft Active Directory for authentication and authorization. However, this software generally does not use the content of those systems to assign assets to protection policies and keep the assignments current. In a company with potentially tens of thousands of employees, employee devices, and the constant change involved with people being added, promoted, reassigned, or removed on an almost daily basis, administrators are forced to rely on either manual efforts or external, static automation workflows to update assignments. All of this adds significant administrative overhead, as well as gaps in data protection, and opportunities for data breaches.

In addition, a company's organizational chart can change for many reasons, such as promotions, demotions, re-organizations, workforce reductions, acquisitions, divestitures, and so on. As the organizational chart changes, an individual's position and relative importance in the overall hierarchy change accordingly. However, while someone might find themselves one or more levels lower in the hierarchy after a change, their relative importance does not change overnight; rather, it adjusts over time. In fact, their relative importance may end up staying the same or even increasing based on the people with whom they continue to communicate.

What is needed, therefore is a data protection system that automatically incorporates organizational awareness and historical data to efficiently apply data protection policies or policy attributes to specific assets within an organization and thereby eliminate present manual or ad-hoc methods of tagging data to the policies.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. EMC, Data Domain and Data Domain Restorer are trademarks of DellEMC Corporation.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a diagram of a network implementing an organization classifier to assign assets to data protection policies, under some embodiments.

FIG. 2 is a flowchart that illustrates an overall method of assigning assets to data protection policies using automated organization awareness, under some embodiments.

FIG. 3 illustrates the interconnection between the organization classifier and backup software components in a data protection environment, under some embodiments.

FIG. 4 illustrates an example graph for an organization showing a hierarchy of certain personnel and devices, as used in some embodiments.

FIG. 5 is a flow diagram illustrating a process generating a score for people within a hierarchy for application of data protection policies, under some embodiments.

FIG. 6 illustrates the composition of the total score calculated by the organization classifier, under some embodiments.

FIG. 7A is a first table illustrating some an example of a set of scores for an organization, under an example embodiment.

FIG. 7B is a second table illustrating the impact of personnel changes to the example table of FIG. 7A.

FIG. 8 is a table that illustrates the mapping of total scores to available data protection policies, under an example embodiment.

FIG. 9 is an example organization classifier graph showing scores with historical data, under some embodiments.

FIG. 10 is a flowchart that illustrates a method of calculating an overall organization classifier score using historical weighting, under some embodiments.

FIG. 11 illustrates a calculation of organization classifier scores using historic weighting and no boost values, under an example embodiment.

FIG. 12 illustrates a calculation of organization classifier scores using historic weighting and boost values, under another example embodiment.

FIG. 13 is a system block diagram of a computer system used to execute one or more software components of an organization awareness process for automating data protection policies, under some embodiments.

### DETAILED DESCRIPTION

A detailed description of one or more embodiments is provided below along with accompanying figures that illustrate the principles of the described embodiments. While aspects are described in conjunction with such embodiment(s), it should be understood that it is not limited to any one embodiment. On the contrary, the scope is limited only by the claims and the described embodiments encompass numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the certain methods and processes described herein. Applications may also be downloaded, in whole or in part, through the use of a software development kit or toolkit that enables the creation and implementation of the described embodiments. In this specification, these implementations, or any other form that embodiments may take, may be referred to as techniques. In general, the order of the steps of disclosed processes may be altered within the scope of the embodiments.

Some embodiments involve data processing in a distributed system, such as a cloud based network system or very large-scale wide area network (WAN), and metropolitan area network (MAN), however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

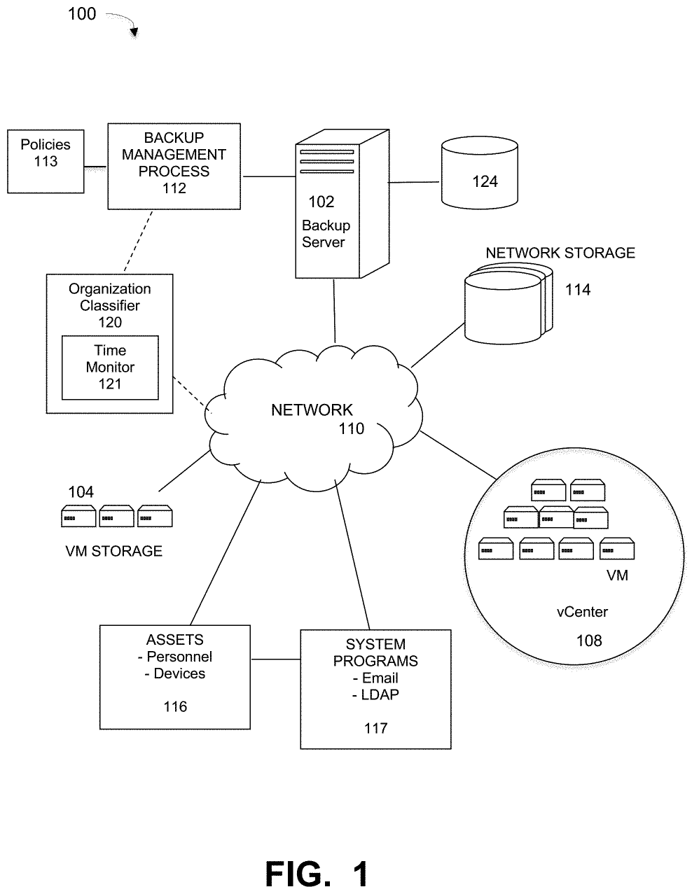

FIG. 1 illustrates a computer network system that implements one or more embodiments of implementing organization awareness for automating data protection policies, under some embodiments. In system 100, a storage server 102 executes a data storage or backup management process 112 that coordinates or manages the backup of data from one or more data sources 108 to storage devices, such as network storage 114, client storage, and/or virtual storage devices 104. With regard to virtual storage 104, any number of virtual machines (VMs) or groups of VMs may be provided to serve as backup targets. FIG. 1 illustrates a virtualized data center (vCenter) 108 that includes any number of VMs for target storage. The backup server implements certain backup policies 113 defined for the backup management process 112, which set relevant backup parameters such as backup schedule, storage targets, data restore procedures, and so on. In an embodiment, system 100 may comprise at least part of a Data Domain Restorer (DDR)-based deduplication storage system, and storage server 102 may be implemented as a DDR Deduplication Storage server provided by EMC Corporation. However, other similar backup and storage systems are also possible.

The network server computers are coupled directly or indirectly to the network storage 114, target VMs 104, data center 108, and the data sources 106 and other resources 116/117 through network 110, which is typically a public cloud network (but may also be a private cloud, LAN, WAN or other similar network). Network 110 provides connectivity to the various systems, components, and resources of system 100, and may be implemented using protocols such as Transmission Control Protocol (TCP) and/or Internet Protocol (IP), well known in the relevant arts. In a cloud computing environment, network 110 represents a network in which applications, servers and data are maintained and provided through a centralized cloud computing

Backup software vendors typically provide service under a service level agreement (SLA) that establishes the terms and costs to use the network and transmit/store data specifies minimum resource allocations (e.g., storage space) and performance requirements (e.g., network bandwidth) provided by the provider. The backup software may be any suitable backup program such as EMC Data Domain, Avamar, and so on. In cloud networks, it may be provided by a cloud service provider server that may be maintained be a company such as Amazon, EMC, Apple, Cisco, Citrix, IBM, Google, Microsoft, Salesforce.com, and so on.

In most large-scale enterprises or entities that process large amounts of data, different types of data are routinely generated and must be backed up for data recovery purposes. This data comes from many different sources and is used for many different purposes. Some of the data may be routine, while others may be mission-critical, confidential, sensitive, and so on. As shown in the example of FIG. 1, the assets can include not only data sources, such as VMs 108, but other sources 116 that generate data or that require or benefit from different data backup and restore schedules. These can include the people of the organization, their devices, certain facilities, and so on. For example, if a certain class of personnel, such as executives create particularly sensitive or important data, policies that ensure secure and fast storage may be implemented for them, their devices, their teams, and so on, as opposed to having their data routinely archived with all the other normal data in the system. The assets 116 are often managed by access and control programs such as LDAP and/or they utilize certain critical programs within the company, such as e-mail, application software, and so on. System 100 includes an organization classifier component 120 that analyzes such programs to determine the appropriate backup policies 113 to apply to the assets 116.

As shown in FIG. 1, system 100 includes an organization classifier 120, which analyzes directory services and email systems to assign scores to users based on their positions within the company. The backup management process 112 can then use those scores to intelligently assign protection policies 113 to certain people. For instance, the OC can enable backup software to determine who in the organization is part of the executive core of the company and assign a policy with a 15-minute Recovery Point Objective (RPO), while systems belonging to less critical employees are assigned hourly or daily RPOs. In this manner, the data protection policy assignment is dynamic and scalable, while minimizing the work required from administrators or external workflow automation systems.

For the embodiment of FIG. 1, the organizational classifier 120 may be implemented as a component that runs within a data protection infrastructure, and can be run as an independent application or embedded into an instance of data protection software 112 or as part of a data protection appliance. Any of those implementations may also be on-premise implementations on client machines within a user's data center or running as a hosted service within the cloud.

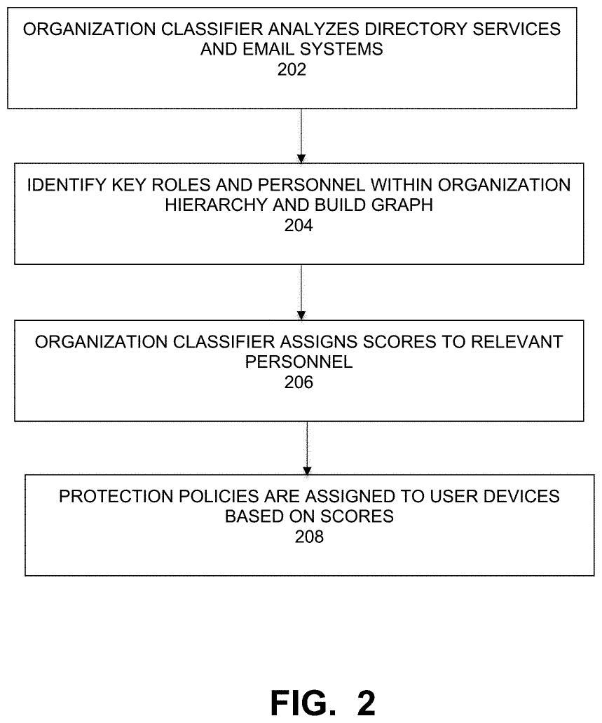

FIG. 2 is a flowchart that illustrates an overall method of assigning assets to data protection policies using automated organization awareness, under some embodiments. For this process, the organization classifier analyzes directory services and e-mail systems, along with any other relevant personnel interaction platforms, 202. The directory services provide information about the formal hierarchy of the organization, while the e-mail and other programs provide insight into informal or more practical relationships among the personnel. Through this analysis the key roles and personnel are identified within the organization hierarchy, 204. The organization classifier then builds its own graph mapping devices to people and people to each other in the hierarchy. The organization classifier calculates and assigns a score to each identified person, 206. These scores are then used by the data protection system to intelligently automate the assignment of users' devices to specific protection policies, 208.

The process of FIG. 2 provides a way to easily assign different policies to different people, or to the same people at different times depending on different data contexts. For example, data for top level personnel may always be protected at the highest level, but people involved in a particular project may have their data protected at this same level while working on the project, but revert to normal levels of data protection afterward. Likewise, some people identified by the e-mail or other programs may be flagged as generating highly important data, even though their position in the formal hierarchy alone may not warrant the application of special data protection policies. Furthermore, certain data protection policies may be defined for certain contexts, such as movement and storage of legal documents during litigation, where strict legal rules and court orders dictate data processing, or storage of medical records subject to HIPAA compliance, and so on.

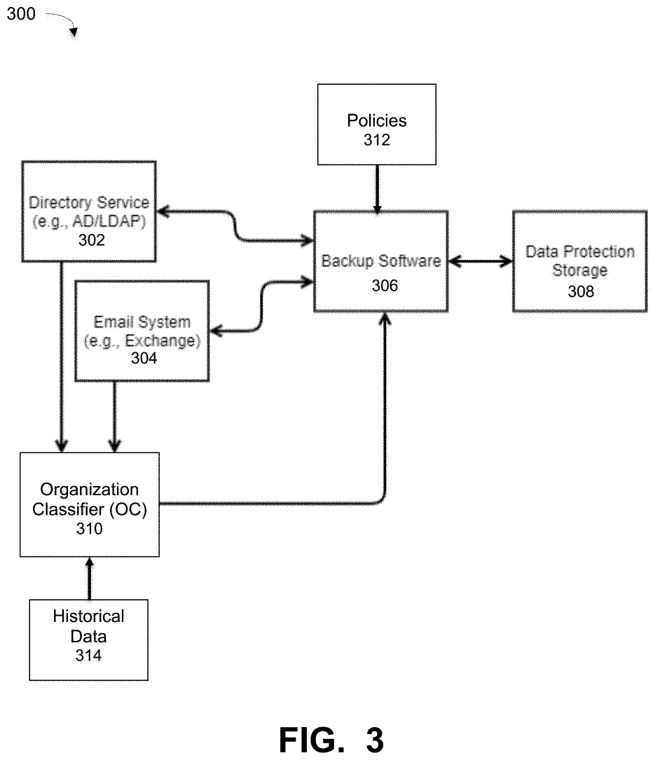

FIG. 3 illustrates the interconnection between the organization classifier and backup software components in a data protection environment, under some embodiments. As shown in diagram 300 of FIG. 3, the organization classifier component 310 takes inputs from directory services 302 and Email systems 304 and internally generates a graph (or other representation) of the organization. The organization classifier then uses that graph to assign a score to each individual, where the score represents their importance level within the organization, and keeps those scores updated as the organization changes. The scores are then used by backup software 306 to assign protection policies 312 to those individuals' devices, such as their desktop computers, notebook computers, tablets, phones, and so on. These policies dictate backup schedules for storing the data in data protection storage 308, which may be tiered to provide different protection characteristics based on cost.

Inputs to the organization classifier 310 and backup software 306 is typically already integrated with directory services such as LDAP or Microsoft Active Directory, or similar. LDAP represents a type of application protocol for maintaining distributed directory information services over IP networks. Such directory services may provide an organized set of records in a hierarchical structure, such as a corporate e-mail directory. Although embodiments are described with respect to LDAP, any similar protocol can be used.

The organization classifier 310 can either share the configuration of one or more directory services 302 with the backup software 306, or the services 302 can be directly configured in the organization classifier itself. The backup software 306 may also be protecting the e-mail system 304 itself, and these this system may be using one of the directory services 302 to implement their Global Address Lists (GALs), or they may have their own internal corporate directories. The organization classifier 310 can either share the configuration of such systems with the backup software 306, or the services can be directly configured in the organization classifier itself. In a traditional organization, the GAL is considered sufficient to capture the full organization chart, but other embodiments of this component may integrate with other Enterprise Resource Planning (ERP) tools (e.g., Workday) to collect additional information about employees.

In an embodiment, the organization classifier 310 maintains an internal data structure represented as a graph. The graph is stored using a graph database, but other embodiments may use other data storage, such as a relational database, and the like. In a graph database, each node in the graph represents an object of a type including Domain, Group, User, Device, among others.

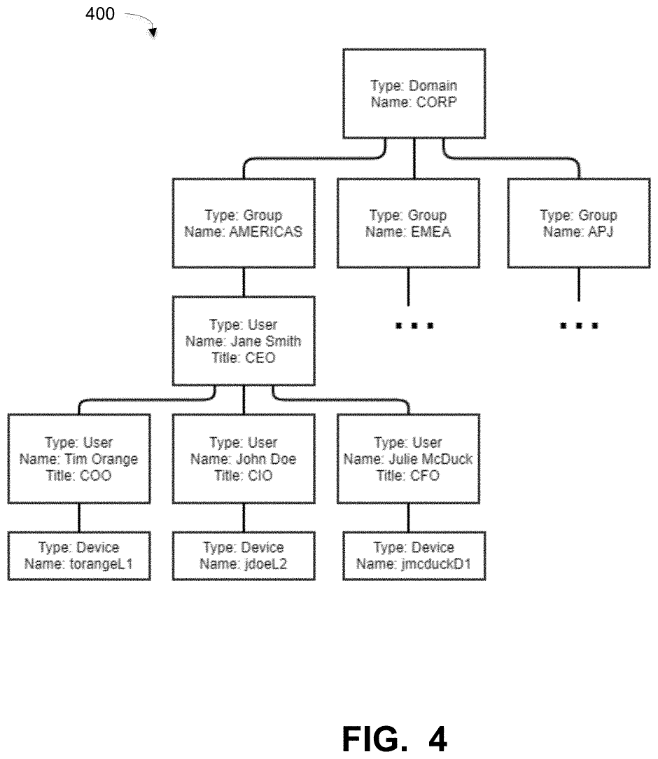

FIG. 4 illustrates an example graph as generated by the organization classifier for an organization showing a hierarchy of certain personnel and devices, as used in some embodiments. Graph 400 illustrates a graph based on objects of the types Domain, Group, User, and Device. The Domain object is a top level object and corresponds to the corporation or organization as a whole. This organization may be divided among different geographical regions, which each constitute a Group within the hierarchy. Each region then has a number of different people, each represented as a different User node. Each person may control one or more devices denoted by the Device nodes assigned to each User.

As shown in in FIG. 4, there is a many-to-one mapping of Devices to Users. In other words, a User may have one or more devices, but each device is assigned to only one primary User. The initial information regarding devices mapped to users may (typically) be provided by the LDAP system itself where company equipment is under custodial care of individual users. Alternatively, other databases may be used to provide this device to user assignment, such as IT department logs, and so on, if necessary.

With regard to the relationships among the people, there is a many-to-many mapping of Users to Groups. A User can be part of one or more Groups, and a Group may have one or more Users. Both Users and Groups have a many-to-one mapping to a Domain. Each User and each Group can be part of only one Domain. Diagram 400 is provided for purposes of illustration only, and many other hierarchies, node structures, and configurations may be used.

In general, the structure and content of the internally generated graph 400 should match, at least loosely, the original LDAP information. However, certain distinctions or other information may inform the organization classifier's internally generated graph depending on the analysis procedure. For example, when also integrated with an ERP system, the information from the ERP system may create differences between the internal graph and the LDAP source. An important element of the organization classifier graph, such as shown in FIG. 4, is the explicit mapping of devices to people within the hierarchy, as the policies regarding data backup will be imposed directly on these devices based on the identity of the device user.

The native types of each directory system are mapped to the types present within the organization classifier. For example, an Active Directory Organizational Unit (OU) maps to a Group. A set of key/value pairs are also associated with each node. These are used to cache data for the calculation of scores (as described below), such as number of emails received or sent.

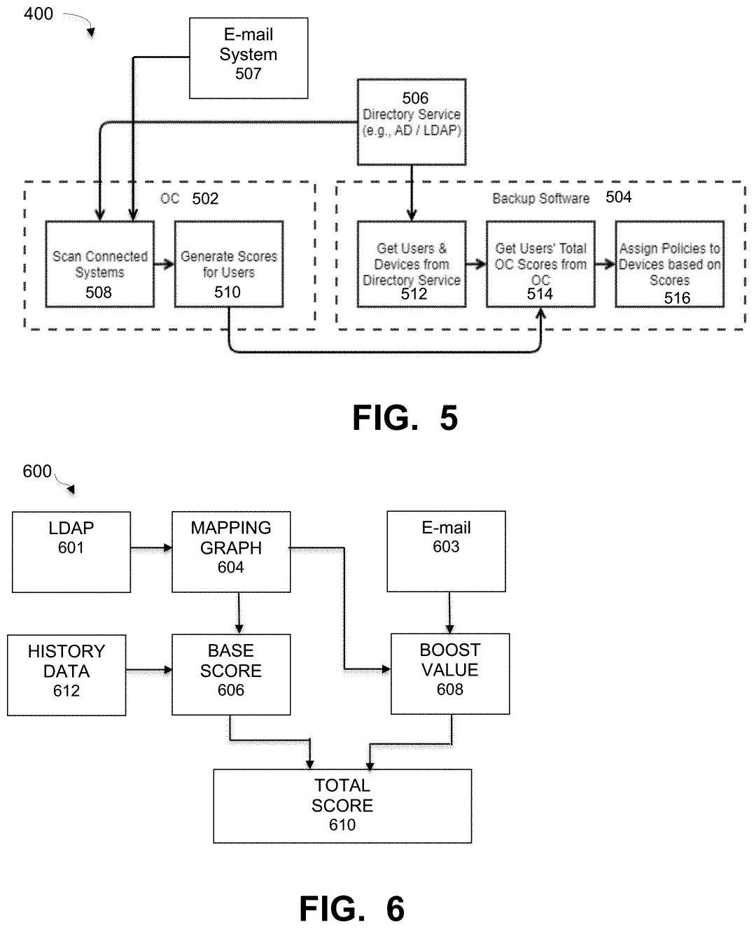

With reference back to FIG. 2, once the graph 400 is generated, the organization classifier assigns scores to each of the people. FIG. 5 is a flow diagram illustrating a process generating a score for people within a hierarchy for application of data protection policies, under some embodiments. As shown in diagram 500 of FIG. 5, the organization classifier 502 scans through connected systems in step 508. For each directory service system configured, the classifier 502 scans through and maps the objects within the directory service to its internal graph (e.g., 400). The scan is performed using the LDAP protocol 506.

Another connected system may be the company e-mail system 507. For each email system, if the email system is using one of the configured directory services for its user list, the classifier 502 scans through the mailboxes and extracts statistics, such as total number of emails, and adds those as key/value pairs to the node of the graph corresponding to the User who owns that mailbox. If an email system is not itself connected to a directory service, the classifier 502 will search its connected directory services for a matching email address to associate the Users. If no match is found, then the mailbox is ignored. Besides an e-mail system, other communication platforms may also be scanned, such as chatrooms, social network sites, electronic bulletin boards and so on. The e-mail system 507 data is used to cull information regarding user interactions that may help inform each individual's influence, impact, or importance in the company or a group. Such information may tend to indicate that the data used by that individual is more or less important than their simple LDAP hierarchy data may suggest. This data thus represents informal user interaction information that is used to supplement the formal data provided by the directory service 506. This informal information is not used to change a person's position in the generated graph, but rather to help modify the scoring of that person.

As shown in FIG. 5, after the classifier 502 scans the connected systems, it then generates the scores for the users, 510. In the organization classifier, each user in the graph is assigned a total score calculated as the sum of a base score minus a boost value. This is easily expressed in the following equation as:

Total OC Score=Base Score−Boost Value

The Base Score is assigned according to a user's position in the top-down corporate organizational chart, while the boost value is derived from the informal data (e.g., e-mails, communication patterns, and so on) along with certain organizational data. A lower total score indicates a higher importance within the company.

FIG. 6 illustrates the composition of the total score calculated by the organization classifier, under some embodiments. As shown in FIG. 6, the total score 610 is the combination of the base score 606 and the boost value 608. The base score is derived from the graph or map generated by the organization classifier 502 based on the directory service (LDAP) data 601. The boost value 608 is derived from the unstructured or informal communication information provided by the e-mail system and other similar programs used by people in the company. In addition, certain information from the graph 604 may also be used for the boost value, such as a user's membership or participation with certain other people or devices in the company. An example of the derivation of a total score, will be provided below.

With respect to the base score 606, this score is calculated on the basis of a user's location at in the graph, where the graph position corresponds to a user's ‘importance’ in the company, therefore the value of his or her data. An inverse scale is used so that a lower number denotes higher importance. A person at the top of the chart who does not report to anyone else, such as the President or CEO, has a base score of 1. Their direct reporting personnel (e.g., VPs) each have a base score of 2, those users' direct reporting personnel each have a base score of 4, and so on, with the score doubling for each level. An inverse scoring scale is used so that the graph can extend to an arbitrary number of levels without affecting the scores at the higher levels of the graph. Other embodiments may implement different scoring mechanisms, such as linearly increasing by a fixed number of points per level of hierarchy, normalizing the score to a specified range, or using a method where higher scores indicate higher importance, and so on.

The boost value is a numerical value subtracted from the base score based on one or more rules that capture the impact of a user's communications, associations, impact on other user, as well as any contextual situations impacting their data, such as special projects, temporary assignments, and so on. Table 1 below illustrates some example components of the boost value, in an example embodiment.

TABLE 1
Number of e-mail messages
E-mail Sender/Receiver Identity
Grouping with higher level users
Project assignments
External/Internal Associations

The example of Table 1 lists only some possible boost value factors, but generally represents the most salient factors of a user's communication and association within a company that may impact the value of their data. Any number of such factors may be used, and weighted relative to one another to derive a boost value for the individual.

Using Table 1 as an example, the number of work related e-mail messages received by a person is used to indicate their involvement in the company and therefore, to some degree at least, their importance in the company. Just as important, however, may be the people to whom this user is communicating. So, if the user receives a high number of e-mail messages, and if the number of email messages received per week from a user's manager, or other equally or higher-level managers from other parts of the organization, and exceeds a configurable threshold (e.g., 20 per week), that user's boost value may be set accordingly, where a lower boost value helps lower the overall score. This kind of data is provided almost exclusively by the e-mail programs, as well as other similar communication platforms (chatrooms, etc.).

As shown in FIG. 6, the boost value can also be impacted by the mapping graph 604. Thus, for example, if a group to which the user belongs within the directory system contains at least some configurable percentage (e.g., 60 percent) of other users at higher levels in the organization, their boost value can be adjusted accordingly. Likewise, if the number of groups to which the user belongs that contain users at the top levels of the organization exceeds a configurable threshold (e.g., 3 groups), then the boost value may be similarly adjusted. Internal or external associations with certain groups or people, as may be gleaned from the scanned communication channels may also impact a boost value. For example, a person who is part of an industry group or standards committee may use data that is important. The user's context outside of the formal company hierarchy may also be factored in, such as if the user is part of a special group or involved in an important current project, and so on.

These rules for determining the boost values are coded into the organization classifier 502, but other embodiments may allow for rules to be specified in an externalized resource file. The boost value can show that a person whose position in the organizational chart may be lower than another person's is effectively equally or more important than the other person based on their interactions with other important users or interaction with important data. Boost values can increase (negative boost value) or decrease (positive boost value) the user's overall score based on the factors considered.

With respect to determining an actual boost value for a user, in an embodiment, a threshold value is defined for each of the factors (such as those listed in Table 1). The organization classifier 502 derives a numeric value for each factor over the course of a scan 508 and compares the derived number to the defined threshold and assigns a zero, negative, or positive boost value for each measured factor. Alternatively, a system administrator can review the factor values received for a user and derive an appropriate boost factor for that user. For example, the system may be configured to allow only negative boost values to increase a user's importance, or it may also allow positive boost values to decrease a user's importance as well, and it may provide a manual override by an administrator.

This boost value is then combined with the base score 606 to derive the total score. The organization classifier 502 re-generates all scores at a fixed interval (e.g., daily), so the scores are dynamic in response to organizational changes such as promotions, reassignments, re-organizations, and so on.

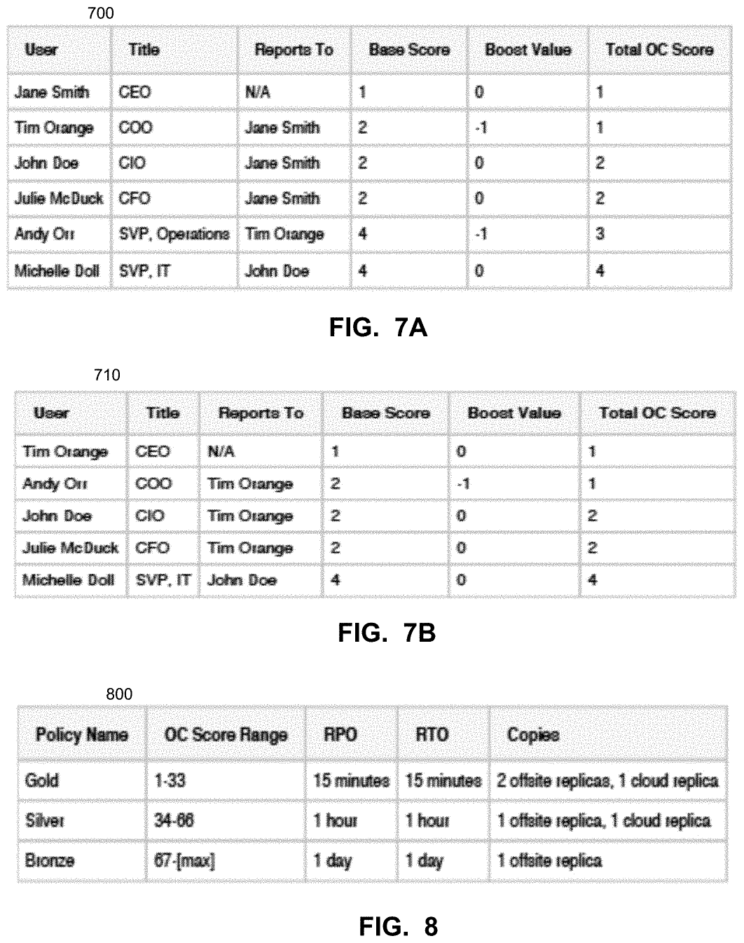

FIG. 7A is a table illustrating some an example of a set of scores for an organization, under an example embodiment. As shown in table 700, each user is listed with their title and reporting lines. This yields a base score derived from their position in the organization graph. Based on certain factors, such as the factors of Table 1 above, each user is then given a boost value, as calculated by the organization classifier. For the example of FIG. 7, it can be seen that in the cases of Tim Orange and Andy Orr, their boost values give them a lower Total OC Score (i.e., higher importance) than others at their level. On a later date, if Jane Smith decides to leave the company, and Tim Orange is promoted to CEO, the scores would be recalculated as shown in table 710 of FIG. 7B, where it can be seen that Tim Orange's base score changes from 2 to 1, and so on.

With reference back to FIG. 5, each user's total score is ultimately used by the backup software 504 to help determine that appropriate backup policies to apply to each user. The backup software 504 directly accesses the directory service database 506 to obtain user and device information for the users, 512. It obtains the total score 514 from the organization classifier 502 as calculated from the base score and boost values described above. Based on the score, the backup software 504 then assigns policies to the devices based on the respective user total score, 516. For this step, the backup software 504 can query the organization classifier 502 via an application program interface (API), such as REST, to retrieve the calculated total score for each user.

As shown in FIG. 5, the backup software 504 queries (in step 512) the directory services 506 for devices associated with the user (e.g., laptops or desktops) and e-mail systems for mailboxes associated with the user. The backup software then applies certain defined rules to map a range of total scores to policy attributes to be applied to those assets, step 516. The backup system may define a number of different backup policies with each policy providing different levels of backup performance or target storage type/location. Important parameters distinguishing these policies typically comprise the number of copies backed up, the target storage type or location, and the RPO (recovery point objective) and RTO (recovery time objective) of the backup data. Typically, higher performance storage or local more secure storage is priced at a higher cost than other types of storage, and thus system administrators must balance data importance against storage costs to cost optimize the data protection operations.

FIG. 8 is a table that illustrates the mapping of total scores to available data protection policies, under an example embodiment. The example table 800 of FIG. 8 lists three different policies in order of Gold, Silver, and Bronze, and which can be priced accordingly by a cloud or storage provider, and each providing different features, such as RPO, RTO and number of copies stored offsite or in the cloud. The possible range of total scores for this example can range from 1 to a maximum score over 67. For the example shown, users with a score of between 1 and 33 have their data stored under the Gold policy, those with scores between 34-66 have their data stored under the Silver policy, and those with scores of 67 above have their data stored under the Bronze policy. The example of FIG. 8 is provided for purposes of illustration only, and any number or characteristics of policies may be provided and used.

The appropriate total score range to assign to each policy may be defined by the system administrator, or it may be set automatically by the backup software based on certain objective data, such as number of total policies, number of distinct RPO/RTO values, number of copies specified, and so on. For the example table 800 of FIG. 8, if the backup software has only three policies, then the software may automatically distribute the score ranges across the policies with the lowest OC Score Range assigned to the policy with the lowest RPO, the next lowest OC Score Range assigned to the policy with the next lowest RPO, and so on. In some cases, the policy applied to a user or group of users based on their scores may conflict with one or more other rules defined by the backup system. In this case, the backup system rules will usually take precedence over any modification of policy assignments suggested by the organization classifier.

Advanced options allow creating backup policies or rules based on specific properties of users or groups of users. For example, systems in a Group associated with Finance may have extended retention periods applied; or users directly or even remotely involved in legal proceedings may automatically have their data held under litigation hold rules, and so on.

### Historical Score Data

The organization classifier embodiments described above assign scores to individuals within a company's reporting structure as represented in a connected Directory Services process (e.g., Microsoft Active Directory), augmented by a “Boost Score” based on signals extracted from connected communication systems (e.g., e-mail). The organizational classifier scores are then used by backup software to automatically assign policies or to assist administrators in assigning policies based on the level of protection desired for a given range of scores. The organizational classifier operates dynamically in that its scores are re-generated on a regular, periodic basis (i.e., daily). However, its scores reflect a snapshot of a point-in-time and do not take into account personnel history nor use hysteresis to smooth out fluctuations in the updates of scores. This can sometimes lead to under-protection of organization data, as the level of protection of individuals' assets drop quickly and their relative importance is re-established relatively slowly.

With reference back to FIG. 3, embodiments of system 300 include an organization classifier 310 that receives and processes certain historical data 314 to modify an individual's base score to compensate for possible continued relative importance within an organization even after the person has been moved within or even left the organization.

With any personnel change (promotion, demotion, re-org, acquisitions, divestiture, etc.) within a company, certain people will move up or down (or out) of the company's organizational chart. As the organizational chart changes, their positions and relative importance in the overall hierarchy change accordingly. A person's new status in the hierarchy usually takes immediate effect after a change, however, their relative importance may not change as quickly, and instead adjust over some period of time. In fact, their relative importance may end up staying the same or even increasing based on the people with whom they continue to communicate. For example, an executive may step down to a lower position or an outside consultancy role and be removed from the formal company org chart, however that person may still be influential and therefore relatively “important” for some period of time after this change due to continuing contact and interaction with present executives and employees. In this example case, the possible importance of an individual based on continuing organization interaction does not correspond with the singular re-organization event; his or her continuing importance may well exist for some time after the re-organization based on their degree of interaction.

As described above, in an embodiment, the organization classifier 310 operates dynamically by re-generating its OC scores on a periodic basis (i.e., daily). These scores reflect a snapshot at each specific point-in-time. For people who move downward or leave an organization, this point-in-time OC score calculation can possibly lead to under-protection of data assets, as the level of protection of an individuals' assets drop quickly (i.e., immediately), while their relative importance is re-established relatively slowly through processing of e-mail and other communication data.

To counteract any such under-protection, embodiments of the organization classifier process 310 factor in certain account history data 314 and use hysteresis to smooth out fluctuations in the updates of OC scores. In an embodiment, the organizational classifier 310 maintains an internal graph to represent the organization chart and re-calculates the scores for each individual after re-scanning connected systems, such as the e-mail 507 and directory service 506 systems. The OC process applies a historical weighting process such that each node in the internal graph keeps the history of scores for 30 days (or any other configurable value). Within the graph generated by the organization classifier 310, present and past (historical) scores are listed for each individual.

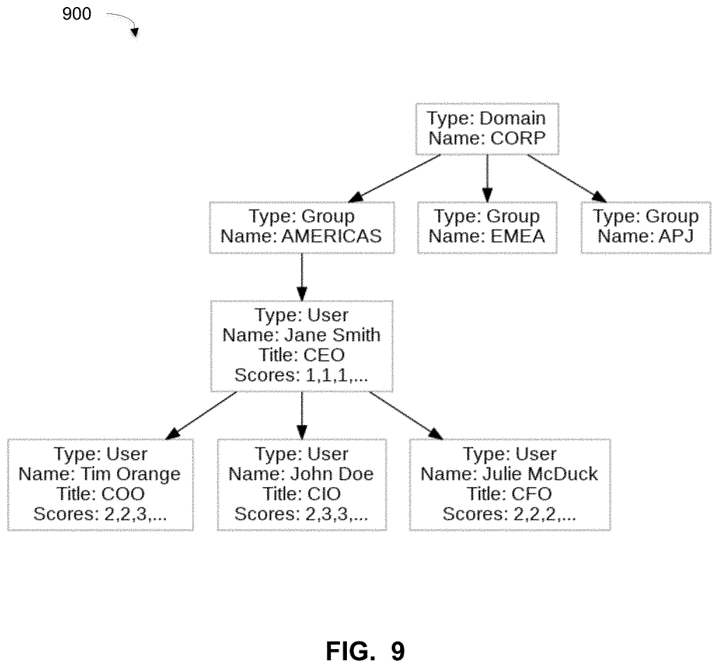

FIG. 9 is an example OC graph showing scores with historical data, under some embodiments. The OC graph 900 of FIG. 9 shows the example OC graph of FIG. 4 with scores and historical data for certain illustrated individuals. Graph 900 of FIG. 9, shows the individuals Jane Smith, Tim Orange, John Doe, and Julie McDuck, each with a sequence of scores, such as 1, 1, 1, . . . (for Jane Smith), and 2, 2, 3, . . . (for Tim Orange), and so on. The sequence of scores may be arranged as: present score, immediate previous score, earlier previous score, and so on to the earliest previous score. Where scores are re-calculated periodically, such as daily, and a practical number of earlier scores, such as 90 scores Thus, for example, individual Tim Orange has a current score of 2, and has previously had scores of 2, 3, . . . , and so on. In a typical case scores are re-calculated daily with a 90-day history, but other time periods are also possible.

The period for re-calculation of the org chart is set by default to daily, for example, such as in the case where there is a change in total OC score downward or upward, and changes happen once per day and take effect immediately. If a company does not change its organization that rapidly, the re-calculation period could be set to a longer period, such as 7, 14, or 30 days and so on.

The number of days, p, to use for the historical weighting means that, each time the score is re-calculated, the system looks to see the difference in a person's position between the current day and p days prior. If a person has gone up the org chart, their total OC score is decreased immediately; otherwise, it is increased linearly over p days. For example, if p is 14, then a person's position 14 days prior is compared to their position at the time of re-calculation, and if they are lower in the org chart since then, that change is applied over the following 14 days. Although their position on the org chart may fluctuate within those prior 14 days, the system uses only the single value from 14 days prior.

In an alternative embodiment, the process uses another factor, r, to specify the number of days across which the score is increased linearly. For example, if r is 7, the process looks back 7 days, but applies any changes over 14 days. In yet another embodiment the process looks at all values across the prior 14 days and applies a formula such as max( ) or average( ) to determine the relative difference between the person's position on the organizational chart.

In general, the amount of historical data is set to a value larger than p, so that the system has enough data to apply the algorithm. Keeping data longer allows for p to potentially be configured to a higher value when needed, but also uses more storage space for the historical data portion of the OC's internal graph. A value like 90 is a reasonable default, but a customer could choose to keep 365 days or even more if the overall organization classifier system has enough storage space available and performance does not suffer.

Under the described embodiments, the organization classifier 310 allows for someone who moves up the hierarchy chart to immediately have their assets protected at a higher level. To maintain a system that favor over-protection of data in a case where a person moving down the organization is not removed immediately, the organization classifier process allows a person who moves down the hierarchy to have their score adjusted over time. In this embodiment, system errs provides higher protection in both cases of a person moving up or down the organizational chart.

In an embodiment, such as shown in FIG. 6, the organization classifier process calculates base scores 606 on the basis of a person's place in the company hierarchy 604 and then subtracts boost values 608 to derive the person's total score 610. A lower total score indicates a relatively higher importance, and boost scores generally help lower a person's score. In an embodiment, the organization classifier 310 uses weighting of historical data 612 to update the base score 606 on a specific day, N.

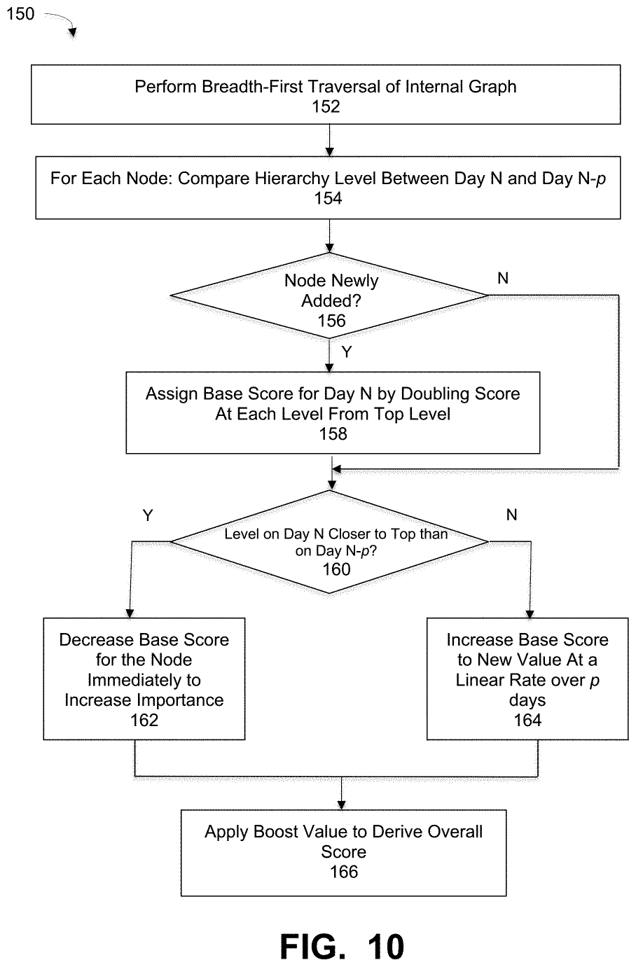

FIG. 10 is a flowchart that illustrates a method of calculating an overall organization classifier score using historical weighting, under some embodiments. As shown in FIG. 10, process 150 begins by performing a breadth-first traversal of the internal graph, 152. In step 154, for each node, the process compares the level on the organizational chart between Day N and Day N−p, where p is a configurable number of days between org chart re-calculations. The value of p this value may be as low as 1, but will typically be a value like 30 days for most organizations.

If the node is newly added on Day N, as determined in decision block 156, then the process assigns the score using a standard method of doubling the score at each level away (down) from the top level, 158. The number of levels away (down) from the top level on Day N (the current day) is compared with the number of levels away (down) from the top level on Day N−p (p days ago) to see whether the person represented by the node has been promoted (relatively more important—decrease base score immediately) or demoted (relatively less important—increase base score to new value at linear rate) within the last p days. Thus, in step 160 it is determined whether or not a node's level on Day N is closer to the top than on Day N−p. If so, the score for the node is decreased immediately, that is, person's relative importance is increased, 162. Otherwise, the score is increased from the existing value to the new value over p days, 164. This increase can be applied at a linear rate over the p days, or alternatively, a variable rate change function can be applied. The process then applies any applicable boost values, 166 and continues processing with the next node.

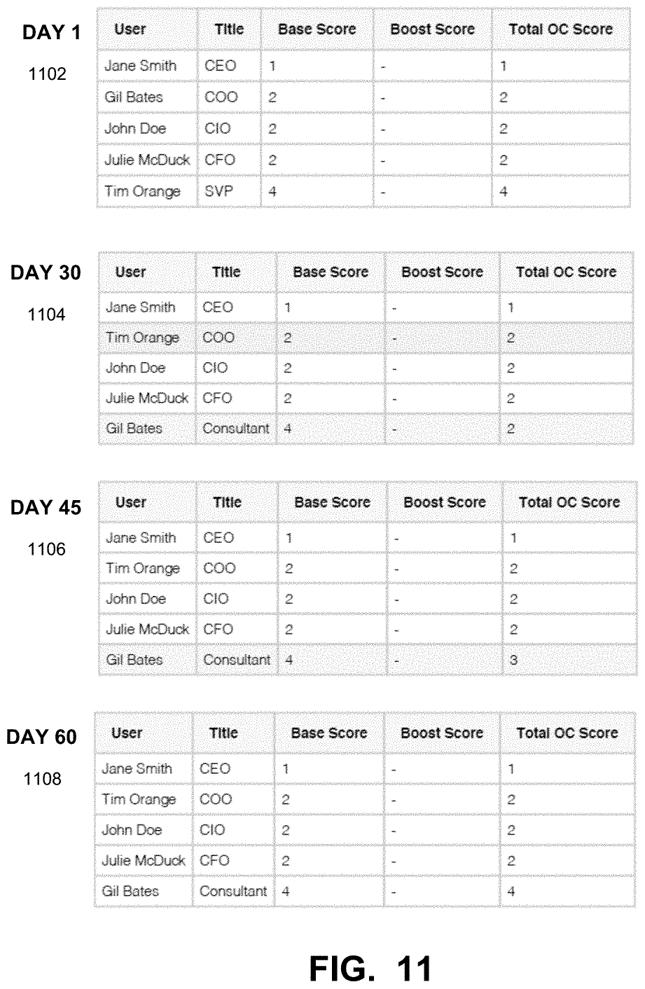

FIG. 11 illustrates a calculation of organization classifier scores using historic weighting and no boost values, under an example embodiment. Each table 1102 to 1108 in FIG. 11 lists illustrative base scores and total OC scores for five officers of the company in decreasing order of importance. In this example, p=30, and base scores are also re-calculated every 30 days. Assume the company starts out with the following users and positions for Day 1 as shown in table 1102.

At some point between Day 1 and Day 30 (table 1104), Gil Bates has decided to step down from the COO role and Tim Orange has been promoted into the COO position. Because the period for re-calculating scores is every 30 days, Day 30 is first day on which the base scores have been updated, so Tim Orange's score immediately decreases (from 4 to 2) to reflect his relatively higher importance relative to his former SVP position. Under the historical weighting process 150, Gil Bates' score is not immediately decreased, but remains the same to avoid a policy under-protection scenario. Although Gil Bates' score is not immediately decreased, it will be decreased over time to satisfy the need to assign new protection policies based on his change. Thus, as shown in table 1106 for Day 45, which is halfway between the initial update (Day 30) and the following update (Day 60) based on p=30, however, Gil Bates' total OC score is proportionately decreased. In this case, his OC score is decreased from 2 to 3, which is half of its final value of 4 based on a linear rate of increase. If other change curves are used, this intermediate value would be accordingly different. As shown in table 1108 for Day 60, which is the next re-calculation point, it can be seen that there have been no other organization changes, and Gil Bates' total OC score reflects its final value of 4.

In general, the historical weighting adds benefit by slowing the declination period, such as in the case of Gil Bates who was previously a COO and is now a Consultant. For example, a Data Protection Administrator can now create a policy where a total OC score between 1-3 is assigned the most stringent protection policy for the data of corporate suite officers. Without the historical weighting, Gil Bates' level of protection would have immediately dropped as if he had always been a Consultant. With the historical weighting, there is now a period of time during which his data is protected at a higher level as he transitions out of the role. By applying the change linearly over time, the system also avoids the problem of more-stringent and less-stringent policies being applied back-and-forth over consecutive days due to larger variations in total OC score over time.

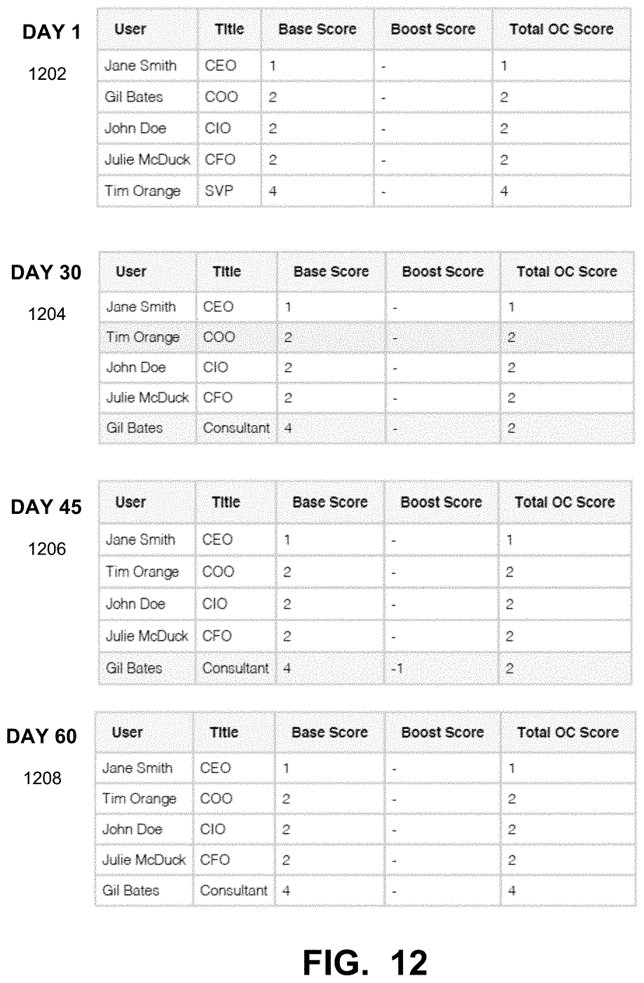

The historical weighting process 150 of FIG. 10 works with our without boost values. FIG. 12 illustrates a calculation of organization classifier scores using historic weighting and boost values, under an example embodiment. Each table 1202 to 1208 in FIG. 12 lists illustrative base scores and total OC scores for five officers of the company in decreasing order of importance, as was illustrated in FIG. 11. In this example again, p=30, scores are re-calculated every 30 days, and boost values are considered. Assume the company starts out with the following users and positions for Day 1 as shown in table 1202.

For this example, the Day 1 organization starts out with the same users and positions as before, and at some point between Day 1 and Day 30, Gil Bates moves down from the COO and is replaced by Tim Orange, as reflected in the Day 30 table 1204 (the first day on which base scores have been updated). Again, Tim Orange's score immediately reflects the higher importance, while Gil Bates' score remains the same to avoid under-protection.

As shown in table 1206 for Day 45, which is halfway between the initial update (Day 30) and the following update (Day 60), Gil Bates has a boost score of −1, due to the fact that e-mails and other signals indicate that he is still in significant communication with other officers, such as to help with the transition, and so on. Absent the boost score, as shown in the previous example of FIG. 11, Gil's total OC Score would have been at 3, but the process accounts for the boost value to further protected against under-protection by allowing a period of time during which the boost score could become a factor. Thus, for this example as shown in table 1206, his total OC score remains at 2 rather than 3. If a protection policy within the company's backup software were set to protect all users with a total OC score of less than or equal to 2 at the highest levels of protection, Gil's assets would still be included within that policy, reflecting their continued importance. As shown in table 1208 for Day 60, which is the next re-calculation point, it can be seen that there have been no other organization changes and the transition from Gil to Tim has completed, and Gil is no longer exchanging the same volume of e-mails as before. In this case, Gil no longer has a boost score, and the total OC score is re-calculated to reflect its final value of 4.

The historical weighting process 150 allows the system to maintain strong data protection policies to be applied to people who otherwise may lose those policies in a way that extends the protection over time rather than right away. This provides an aspect of hysteresis with respect to data policy assignments in that people who are elevated to a higher protection policy category are protected immediately, whereas people who drop from higher to a lower protection policy category are decreased over a period of time. This period of decrease may be modified or controlled by any applicable boost values as well.

The historical weighting process 150 allows the system to automatically assign new total OC scores that dictate data protection policies for people who move within an organization chart. Such automatic assignments can be overridden by manual assignment of scores and/or explicit data protection policy assignments by system administrators, such as may be required in special or extraordinary circumstances, or to conform to different data protection requirements.

Although embodiments have been described with respect to a linear (or similar) increase of total OC score over time based on historical data and boost values, embodiments are not so limited. An initial time period for decrease in protection policies (i.e., increase in total OC score) may be shortened based on certain circumstances. For example, an initially linear increasing score curve may be accelerated based on user-defined characteristics such as personnel issues, company activity, external factors, and so on.

The embodiments described herein optimize data backup operations by using information from directory service systems (e.g., LDAP, Active Directory), as well as communication programs (e.g., e-mail) to automatically apply data protection policies to users based on their individual status and data usage patterns. The embodiments further accommodate historical weighting to prevent under-protection of data assets by allowing continued full application of data policies for a certain period of time to people who move and may otherwise be subject to lower policy protections that may be implemented immediately otherwise.

### System Implementation

Embodiments of the processes and techniques described above can be implemented on any appropriate backup system operating environment or file system, or network server system. Such embodiments may include other or alternative data structures or definitions as needed or appropriate.

The processes described herein may be implemented as computer programs executed in a computer or networked processing device and may be written in any appropriate language using any appropriate software routines. For purposes of illustration, certain programming examples are provided herein, but are not intended to limit any possible embodiments of their respective processes.

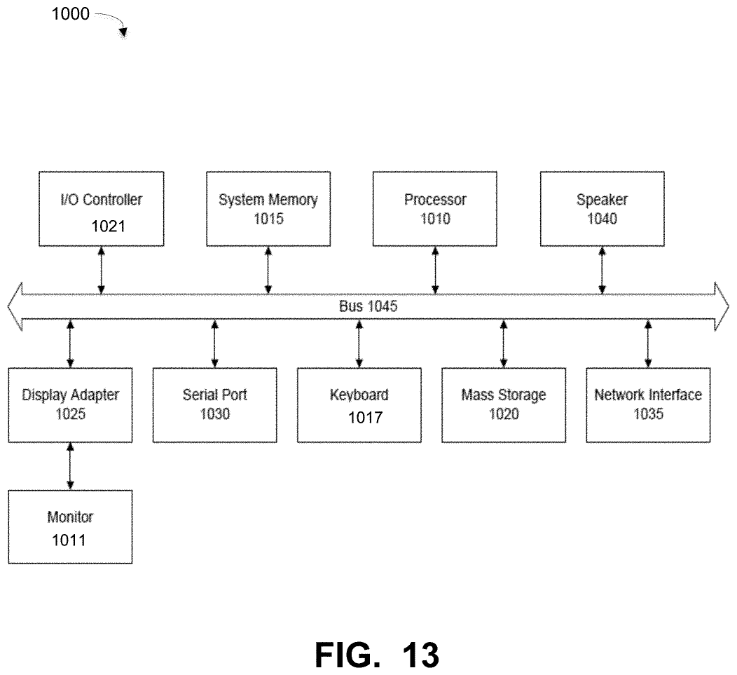

The network of FIG. 1 may comprise any number of individual client-server networks coupled over the Internet or similar large-scale network or portion thereof. Each node in the network(s) comprises a computing device capable of executing software code to perform the processing steps described herein. FIG. 13 shows a system block diagram of a computer system used to execute one or more software components of the present system described herein. The computer system 1000 includes a monitor 1011, keyboard 1017, and mass storage devices 1020. Computer system 1000 further includes subsystems such as central processor 1010, system memory 1015, I/O controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 is just one example of a computer system suitable for use with the present system. Other configurations of subsystems suitable for use with the described embodiments will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system 1005 may be one of the Microsoft Windows®. family of systems (e.g., Windows Server), Linux, Mac OS X, IRIX32, or IRIX64. Other operating systems may be used. Microsoft Windows is a trademark of Microsoft Corporation.

The computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of the system using a wireless network using a protocol such as Wi-Fi (IEEE standards 802.11, 802.11a, 802.11b, 802.11e, 802.11g, 802.11i, 802.11n, 802.11ac, and 802.11ad, among other examples), near field communication (NFC), radio-frequency identification (RFID), mobile or cellular wireless. For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

For the sake of clarity, the processes and methods herein have been illustrated with a specific flow, but it should be understood that other sequences may be possible and that some may be performed in parallel, without departing from the spirit of the described embodiments. Additionally, steps may be subdivided or combined. As disclosed herein, software written in accordance certain embodiments may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method of automating backup policy application to users in a data protection system of an organization, comprising:
obtaining organizational hierarchy information about the users from a directory service used by the organization and indicating a hierarchy of the users in the organization;
deriving a base score for each user based on a position of the user within the organization;
assigning a backup policy of a plurality of different backup policies to each user based on their respective base score, wherein the different backup policies are arranged in order of strength from strongest to weakest protection;
detecting a change of a user within the hierarchy of the organization;
immediately assigning, upon the change, a stronger protection policy if the user moves to a higher position in the hierarchy; and
assigning, after an overall period of time, a weaker protection policy if the user moves to a lower position in the hierarchy.

2. The method of claim 1 further comprising periodically re-scanning the organization hierarchy to generate a history of scores for each user.

3. The method of claim 2 wherein the period of the re-scanning is one of: daily, monthly, quarterly, or annually.

4. The method of claim 2 further comprising:
obtaining communication and grouping information about the user from one or more communication programs used by the users;
deriving a score modifier value from the communication and grouping information;
calculating a total score for each user by combining its respective base score and score modifier value;
defining a total score range to each policy of a plurality of backup policies provided by the data protection system; and
applying a respective policy to data process by the user based a match of their respective total score relative to the total score range of the respective policy.

5. The method of claim 4 wherein the user is assigned the total score as an initial score in the respective history of scores, and further wherein the user is assigned a final score after moving to the lower position in the hierarchy.

6. The method of claim 5 wherein the total score is decreased linearly from the initial score to the final score over the overall time period, and wherein the overall period of time comprises one or more re-scanning periods.

7. The method of claim 1 wherein the each backup policy of the plurality of backup policies specifies a target storage location, a recovery time objective, and a recovery point objective for data backed up under the backup policy.

8. The method of claim 1 wherein the directory service comprises one of a Lightweight Directory Access Protocol (LDAP) database, or a Microsoft Active Directory database, and further wherein the one or more communication programs comprise at least one of an e-mail program, a chat program, a social network platform, and an electronic bulletin board program.

9. The method of claim 1 wherein the base score is scored on an inverse scale and is derived directly from the user position in the hierarchy with top level users having no upward reporting lines assigned a lower score and middle and lower level users with multiple upward reporting lines having positive integer scores proportional to a number of reporting lines.

10. The method of claim 9 wherein the score modifier value is derived by taking into account at least one of a plurality of factors defining communication and grouping activities of a user, and further wherein the factors comprise at least one of: a number of e-mail messages transacted in a period of time, a relative hierarchical level to the user of senders and receivers of the e-mail messages, association in one or more groups with users of a higher hierarchical level; and association with people or groups inside or outside of the organization.

11. A computer-implemented method of automating backup policy application to users in a data protection system of an organization, comprising:
defining a plurality of backup policies to apply to data processed by users in the organization, wherein each backup policy dictates a different performance characteristic based on storage cost and target storage type and location, and are ordered from strongest to weakest protection based on cost;
identifying a hierarchical position of a user within the organization;
determining communication and grouping behavior of the user within the organization;
assigning an initial protection policy to a user based on the communication and grouping behavior; and
assigning a final protection policy to the user upon a move of the user to a different hierarchical position, wherein the final protection policy is immediately applied if the user moves to a higher position in the organization, or applied over a period of time if the user moves to a lower position in the organization.

12. The method of claim 11 further comprising periodically re-scanning the organization hierarchy to determine a hierarchical position of each user, and wherein the period of the re-scanning is one of: daily, monthly, quarterly, or annually.

13. The method of claim 12 further comprising calculating a total score for the user based on the hierarchical position and communication and grouping behavior to automatically assign a policy of the plurality of backup policies to a data processing device operated by the user based on the total score for the user, wherein the total score is derived by combining a base score with a score modifier value, wherein the base score is derived from the hierarchical position of the user in the organization.

14. The method of claim 13 wherein the base score is scored on an inverse scale and is derived directly from the user position in the hierarchy with top level users having no upward reporting lines assigned a lower score and middle and lower level users with multiple upward reporting lines having positive integer scores proportional to a number of reporting lines, and further wherein the score modifier value is derived by taking into account at least one of a plurality of factors associated with the communication and grouping activities of the user and quantifiable by the one or more communication programs.

15. The method of claim 14 further comprising:
assigning the user the total score as an initial score in a respective history of scores;
assigning the user a final score after moving to the lower position in the organization; and
decreasing the total score linearly from the initial score to the final score over the overall time period, and wherein the overall period of time comprises one or more re-scanning periods.

16. The method of claim 11 wherein the each backup policy of the plurality of backup policies specifies a target storage location, a recovery time objective, and a recovery point objective for data backed up under the backup policy.

17. A computer-implemented method of automating backup policy application to users in a data protection system of an organization, comprising:
defining a plurality of backup policies to apply to data processed by users in the organization, wherein each backup policy dictates a different performance characteristic based on storage cost and target storage type and location, and are ordered from strongest to weakest protection based on cost;
identifying a first hierarchical position of a user within the organization and a second hierarchical position of the user after a move;
determining communication and grouping behavior of the user within the organization;
calculating a total score for the user based on the hierarchical position and communication and grouping behavior to automatically assign a policy of the plurality of backup policies to a data processing device operated by the user based on the total score for the user;
immediately applying a stronger protection policy to the user if the second hierarchical position is higher than the first hierarchical position, otherwise, applying a weaker protection policy to the user after a period of time.

18. The method of claim 17 wherein the stronger protection policy is applied to all users with a total score less than or equal to a defined threshold value, and the weaker protection policy is applied to users with a score greater than the defined threshold value.

19. The method of claim 18 further comprising periodically re-scanning the organization hierarchy to determine a hierarchical position of each user, and wherein the period of the re-scanning is one of: daily, monthly, quarterly, or annually.

20. The method of claim 19 further comprising:
assigning the user the total score as an initial score in a respective history of scores;
assigning the user a final score after moving to the second hierarchical position; and
decreasing the total score linearly from the initial score to the final score over the overall time period, and wherein the overall period of time comprises one or more re-scanning periods.
